(19) United States
(12) Patent Application Publication
(10) Pub. No.: US 2024/0070688 A1
(43) Pub. Date: Feb. 29, 2024

(54) MULTI-ENCODER MODEL ARCHITECTURE FOR CALCULATING ATTRITION

(71) Applicant: U.S. Bancorp, National Association, Minneapolis, MN (US)

(72) Inventors: Giacomo Domeniconi, New York, NY (US); Samuel Assefa, Watertown, MA (US); Ronald Burns, Crystal Lake, IL (US)

(73) Assignee: U.S. Bancorp, National Association, Minneapolis, MN (US)

(21) Appl. No.: 17/898,898

(22) Filed: Aug. 30, 2022

(51) Int. Cl. G06Q 30/02; G06N 3/08

(52) U.S. Cl. CPC G06Q 30/0202; G06N 3/08

(57) ABSTRACT

A method comprises generating a first feature vector comprising a plurality of values for a plurality of transactions, each of the plurality of transactions corresponding to an account and performed within a defined time period, and a second feature vector comprising an attribute value of an attribute of the account; inserting the first feature vector into a first encoder of a machine learning model to generate a transaction embedding and the second feature vector into a second encoder of the machine learning model to generate an attribute embedding; concatenating the transaction embedding and the attribute embedding to generate a concatenated embedding; and generating an account prediction value by propagating the concatenated embedding into a set of prediction layers of the machine learning model.

### BACKGROUND

The proliferation of storage and network devices enables a large amount of data to be exchanged and stored. A large amount of data allows analysis or predictions that were not feasible before. For example, a big data analysis performed on millions of accounts may enable online behavior predictions of consumer behavior.

In some instances, a company entity may wish to identify individuals that will likely leave the company or stop using the company's products. To identify such individuals, the company may employ statistical algorithms with available data about the individuals and identify patterns within the data. For instance, a financial company may seek to identify individuals that will stop using the financial company's products. To do so, a processor operated by the financial company may identify static transaction patterns of transactions the individuals perform over time. If individuals perform transactions in a manner similar to the performed transaction patterns, the processor may flag the individuals with the matching patterns as potential candidates to stop using the financial company's products. However, because financial institutions can store and analyze data for millions of diverse customers, the amount of data and processing resources required to compare the transaction history of each customer to different patterns can be debilitating and require a large amount of computer resources. The problem can be compounded as the processor stores more and more patterns to account for customers with different characteristics and attempts to perform the process repeatedly for individual customers.

### SUMMARY

At least one aspect of a technical solution to the aforementioned problem is directed to a method. The method may comprise generating, by a processor, a first feature vector comprising a plurality of values for a plurality of transactions, each of the plurality of transactions corresponding to an account and performed within a defined time period, and a second feature vector comprising an attribute value of an attribute of the account; inserting, by the processor, the first feature vector into a first encoder of a machine learning model to generate a transaction embedding and the second feature vector into a second encoder of the machine learning model to generate an attribute embedding; concatenating, by the processor, the transaction embedding and the attribute embedding to generate a concatenated embedding; and generating, by the processor, an account prediction value by propagating the concatenated embedding into a set of prediction layers of the machine learning model.

An account prediction value may a value indicating a likelihood of attrition (e.g., churn) of customers. Attrition may mean a customer halting usage of a company's products or reducing such usage to an amount below a threshold. For example, attrition may occur when customers of a financial institution use a transaction card to perform transactions for amounts that individually or in the aggregate do not exceed a threshold (e.g., do not exceed a threshold within a defined time period).

At least one aspect of this technical solution is directed to a system. The system may comprise one or more hardware processors configured by machine-readable instructions to generate a first feature vector comprising a plurality of values for a plurality of transactions, each of the plurality of transactions corresponding to an account and performed within a defined time period, and a second feature vector comprising an attribute value of an attribute of the account; insert the first feature vector into a first encoder of a machine learning model to generate a transaction embedding and the second feature vector into a second encoder of the machine learning model to generate an attribute embedding; concatenate the transaction embedding and the attribute embedding to generate a concatenated embedding; and generate an account prediction value by propagating the concatenated embedding into a set of prediction layers of the machine learning model. A set of prediction layers may include one or more prediction layers.

At least one aspect of this technical solution is directed to a non-transitory computer-readable storage medium having instructions embodied thereon, the instructions being executable by one or more processors to perform a method. The method may comprise generating first feature vector comprising a plurality of values for a plurality of transactions, each of the plurality of transactions corresponding to an account and performed within a defined time period, and a second feature vector comprising an attribute value of an attribute of the account; inserting the first feature vector into a first encoder of a machine learning model to generate a transaction embedding and the second feature vector into a second encoder of the machine learning model to generate an attribute embedding; concatenating the transaction embedding and the attribute embedding to generate a concatenated embedding; and generating an account prediction value by propagating the concatenated embedding into a set of prediction layers of the machine learning model.

These and other aspects and implementations are discussed in detail below. The foregoing information and the following detailed description include illustrative examples of various aspects and implementations and provide an overview or framework for understanding the nature and character of the claimed aspects and implementations. The drawings provide illustration and a further understanding of the various aspects and implementations and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 is an illustration of a system for attrition prediction of an account, in accordance with an implementation;

FIG. 2A is an illustration of a method for attrition prediction of an account, in accordance with an implementation;

FIG. 2B is an illustration of a method for training a model for attrition prediction of an account, in accordance with an implementation;

FIG. 3 is an illustration of a sequence for executing a model for attrition prediction of an account, in accordance with an implementation;

FIG. 4 is an illustration of a sequence for training a model for attrition prediction, in accordance with an implementation; and

FIG. 5 is an illustration of a sequence for training and executing a model for attrition prediction, in accordance with an implementation.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

As previously mentioned, processing the amount of data that is required to predict attrition in customers using a pattern recognition system for a financial institution can require a large amount of computer resources. One attempt to improve over the pattern recognition system is to use a machine learning model, such as a neural network, to make such predictions. For example, a computer may retrieve, for an account, account data from statements, demographics, and/or other data and generate a feature vector from the gathered data. The computer may input the feature vector into a neural network. The computer can execute the neural network to generate a prediction for attrition for the account. Generating such a feature vector can involve a significant amount of “feature engineering” and can require previous knowledge of patterns in the data to adequately train the neural network. Further, because all of the data is input as one feature vector, the neural network may not be trained to have a high accuracy for cases in which behavior over time is a key predictor of attrition.

Implementations of the systems and methods discussed herein overcome these technical deficiencies because they provide a method and model architecture that can account for account behavior (e.g., performed transactions) over time as well as for static attributes that do not involve events that take place at certain instances in time. For example, a computer implementing the systems and methods discussed herein may store a machine learning model that includes multiple encoders (e.g., modules) and one or more sets of prediction layers. The computer may retrieve customer data from separate sources, such as different databases and/or computers. The computer may retrieve data for or that is associated with one or more data sources such as account attributes (e.g., demographic, credit, aggregated data, etc.), and transactional data (e.g., transactions with related data, payments, etc.). The computer can parse the data that is associated with the data sources into two feature vectors. One feature vector may include data for a series of transactions performed over time. Another feature vector may include the attributes of the account. The computer may input the two feature vectors into encoders trained to generate embeddings based on the feature vectors and execute the encoders to generate an embedding (e.g., a numerical vector) from each encoder. The computer may concatenate the embeddings together to create a concatenated embedding and input the concatenated embedding into a set of prediction layers trained to generate an account prediction value (e.g., a value indicating a likelihood of attrition for an account) based on such embeddings. The computer can execute the set of prediction layers with the concatenated embedding as input to generate an account prediction value for the account. In this way, the computer can implement a unique multi-model architecture that can receive and process timeseries transactional data and static (e.g., non-timeseries) attribute data for an account. Thus, the computer can generate results with a higher degree of accuracy and without iteratively applying large numbers of patterns to a large number of stored accounts.

In some cases, the machine learning model may include multiple sets of prediction layers. The different sets of prediction layers may be trained to make predictions (e.g., generate account prediction values) based on the same concatenated embedding. For example, the sets of prediction layers may provide a binary prediction of attrition, a regression prediction of attrition, a delta dollar amount indicating a drop in spending for a future time period, and/or predictive information about next purchases. The computer may input the same concatenated embedding into each of such sets of prediction layers to generate the output predictions. The computer may apply one or more rules to the account prediction values to determine a retention action that can be employed to lower an account prediction value indicating a likelihood of attrition or to otherwise retain the account or the individual associated with the account. In this way, the computer may use the multiple set of prediction layers configuration of the machine learning model to select retention actions to retain individuals and accounts.

In some embodiments, the computer may train the machine learning model using the outputs from multiple sets of prediction layers of the machine learning model. For example, the computer may execute the encoders of the machine learning based on a feature vector of transaction data and a feature vector of account attribute data to generate embeddings. The computer may concatenate the embeddings together to generate a representation of the account and copy or mirror the concatenated embedding for each set of prediction layers of the machine learning model. The computer may label the features vectors with correct or ground truth values for different account prediction values (e.g., different types of account prediction values). The computer may use back-propagation techniques for each set of prediction layers that corresponds to the respectively labeled concatenated embedding to separately train each set of prediction layers to generate account prediction values. The computer may also use back-propagation techniques with the labeled concatenated embeddings to train the encoders of the machine learning model to generate embeddings. In some embodiments, the computer may do so by executing and training one set of prediction layers at a time by training a set of prediction layers and the encoders based on one labeled concatenated embedding for the set of prediction layers and then training another set of prediction layers and the encoders based on another labeled concatenated embedding. Thus, the computer may avoid improperly weighting the encoders based on any individual labeled concatenated embedding.

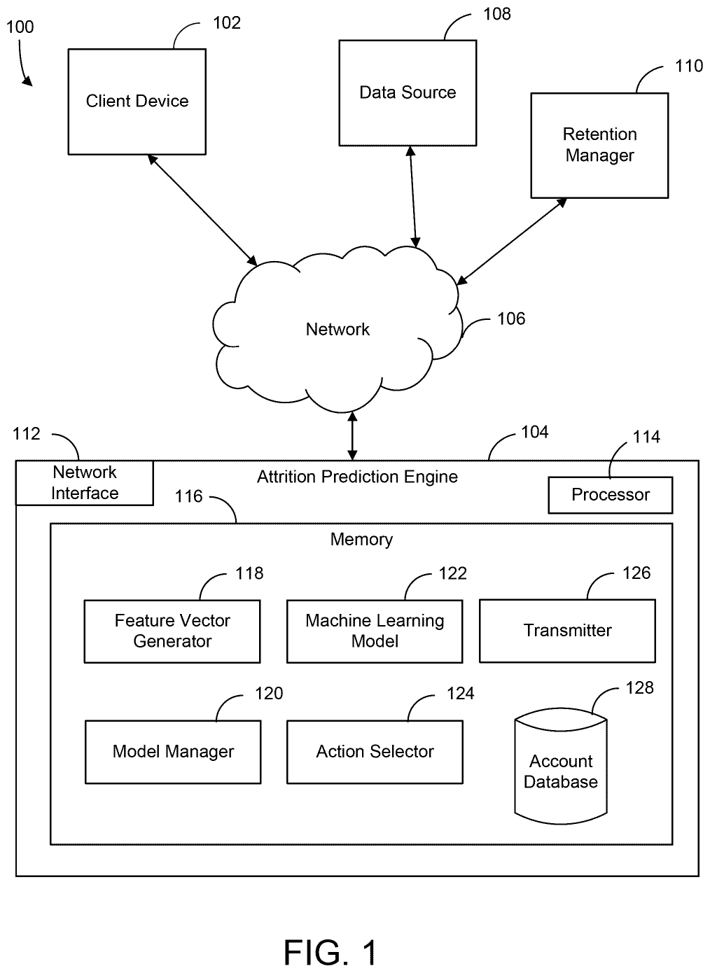

FIG. 1 illustrates an example system 100 for attrition prediction, in some embodiments. In brief overview, system 100 can include a client device 102 that communicates with an attrition prediction engine 104 over a network 106. The attrition prediction engine 104 can communicate with a data source 108 over the network 106 to generate an account prediction value indicating a likelihood of attrition (e.g., a likelihood that a customer or individual will leave a company or stop using a company's (e.g., a financial company's) products or how the owner or operator of the attrition prediction engine 104 defines attrition). The attrition prediction engine 104 can communicate with a retention manager 110 by sending predictions and/or identifications of retention actions to the retention manager 110. System 100 may include more, fewer, or different components than shown in FIG. 1. For example, there may be any number of client devices, computers that make up or are a part of attrition prediction engine 104, or networks in the system 100.

The client device 102 and/or attrition prediction engine 104 can include or execute on one or more processors or computing devices and/or communicate via the network 106. The network 106 can include computer networks such as the Internet, local, wide, metro, or other area networks, intranets, satellite networks, and other communication networks such as voice or data mobile telephone networks. The network 106 can be used to access information resources such as web pages, websites, domain names, or uniform resource locators that can be presented, output, rendered, or displayed on at least one computing device (e.g., client device 102), such as a laptop, desktop, tablet, personal digital assistant, smartphone, portable computers, or speaker. For example, via the network 106, the client device 102 can request for an account prediction value for an account with data stored in memory of the attrition prediction engine 104.

The client device 102 and/or the attrition prediction engine 104 can include or utilize at least one processing unit or other logic devices such as a programmable logic array engine or a module configured to communicate with one another or other resources or databases. The components of the client device 102 and/or the attrition prediction engine 104 can be separate components or a single component. System 100 and its components can include hardware elements, such as one or more processors, logic devices, or circuits.

The attrition prediction engine 104 may comprise one or more processors that are configured to implement a multi-model architecture to create account prediction values (e.g., regression and/or classification likelihood of attrition values, predicted customer spend values, predicted changes in spending values, predicted likely categories of spend, etc.). The attrition prediction engine 104 may comprise a network interface 112, a processor 114, and/or memory 116. The attrition prediction engine 104 may communicate with the client device, the data source 108, and/or the retention manager 110 via the network interface 112. The processor 114 may be or include an ASIC, one or more FPGAs, a DSP, circuits containing one or more processing components, circuitry for supporting a microprocessor, a group of processing components, or other suitable electronic processing components. In some embodiments, the processor 114 may execute computer code or modules (e.g., executable code, object code, source code, script code, machine code, etc.) stored in the memory 116 to facilitate the activities described herein. The memory 116 may be any volatile or non-volatile computer-readable storage medium capable of storing data or computer code.

The memory 116 may include a feature vector generator 118, a model manager 120, a machine learning model 122, an action selector 124, a transmitter 126, and/or an account database 128, in some embodiments. In brief overview, the components 118-128 may cooperate to generate account prediction values for accounts stored in the account database 128. The components 118-128 may do so for an account, for example, by generating a feature vector from transaction data for the account and another feature vector from attribute values of attributes of the account. The components 118-128 may insert the feature vectors into respective encoders trained or otherwise configured to generate embeddings from such feature vectors. The encoders can output embeddings and the components 118-128 can concatenate the embeddings together to generate a concatenated embedding. The components 118-128 can input the concatenated embedding into a set of prediction layers to generate an account prediction value for the account that indicates a likelihood of attrition for the account among other account prediction values.

The attrition prediction engine 104 may store accounts in the account database 128. The accounts may be accounts or profiles for different individuals such as bank accounts, credit card accounts, user profiles with different websites, etc. The accounts may include attribute-value pairs that each include a different attribute and a value for the attribute. For example, the account may include attribute-value pairs for first name, last name, full name, address, phone number, cell phone number, home phone number, tax identification number, street name, zip code, city, state, account number, FICO score, credit limit, age, month of balances, balances, etc. The account database 128 may additionally store data for transactions performed through or by the different accounts in the database. Each transaction may include data about the transaction such as a time the transaction took place, a category (e.g., groceries, leisure, travel, sporting event, food, vehicle, housing, etc.) or categories of items purchased in the transaction, a location of the transaction, a value (e.g., amount) of the transaction, the merchant of the transaction, fees associated with the transaction, etc. The account database 128 may store the data for each transaction with associations with the accounts that correspond to or that were otherwise used to perform the transactions.

The account database 128 may include one or more databases (e.g., databases in a distributed system). The account database 128 may store accounts for different individual entities (e.g., individual people) and/or group entities (e.g., companies, households, organizations, etc.). The accounts may be stored as data structures with one or more attribute-value pairs as described above. The different accounts may be stored in account database 128 and may be updated over time as the attrition prediction engine 104 either receives new values for transactions and/or for attribute-value pairs for the accounts.

The data source 108 may be any computer that stores data regarding individuals that have accounts with (e.g., stored in) the attrition prediction engine 104. The data source 108 may be or include a database or any other type of memory device that is configured to store data. The data source 108 may be owned and/or operated by the same entity that owns and/or operates the attrition prediction engine 104. The data source 108 may be connected to or a part of the same network (e.g., local area network) as the attrition prediction engine 104. The data source 108 may store the same or different data as the data the attrition prediction engine 104 stores in the account database 128. In some embodiments, the attrition prediction engine 104 may retrieve data from the data source 108 when processing data for an account to use the data to generate account prediction scores for the account.

The retention manager 110 may be a computer that is configured to receive identifications of retention actions from the attrition prediction engine 104. The retention manager 110 may receive such identifications and display them on a user interface to an administrator or a user accessing the retention manager 110. The administrator may view the actions and determine whether to implement the action. In some embodiments, the retention manager 110 automatically implements the retention action upon receiving an identification of the retention action. Such may be the case, for example, if the retention action is to automatically send an email, notification, or phone call to an individual that corresponds to the account for which the retention action was selected. The retention manager 110 may receive the identification of the retention action and, depending on the identification, automatically send an email, notification, or phone call to a computing device associated with the individual (e.g., that owns or accesses the computing device).

The feature vector generator 118 may comprise programmable instructions that, upon execution, cause the processor 114 to collect data (e.g., transaction data and/or attribute data) for accounts and generate feature vectors from the collected data. For example, the feature vector generator 118 may retrieve values of transactions performed by an account and an attribute of the account. In retrieving the values of the transactions, the feature vector generator 118 may retrieve values such as timestamps indicating the times and/or days the transactions took place, categories of the transactions (e.g., category of items purchased in the transactions), locations of the transactions, values of the transactions, merchants of the transactions, fees associated with the transactions, etc. The feature vector generator 118 may retrieve the values for the transactions by retrieving values for transactions that were performed within a time period (e.g., a defined time period). The time period may be a defined length of time previous to the current time or a reference time (e.g., a predefined time that may be relative to the current time). For example, the time period may be a time period beginning five days previous to the current time to the current time or a reference time. The feature vector generator 118 may retrieve the values from memory or a database by identifying timestamps associated with transactions that fall within the time period and retrieving the values that correspond to the transactions of the identified timestamps. The feature vector generator 118 may retrieve the values of transactions for the account by retrieving values for transactions that are associated with the account (e.g., have a stored association with an identifier (e.g., a numerical or alphanumerical unique identifier) of the account in memory of the feature vector generator 118).

The feature vector generator 118 can retrieve one or more values of attributes of the account. In retrieving the values, the feature vector generator 118 may retrieve values of attributes for the account such as first name, last name, full name, address, phone number, cell phone number, home phone number, tax identification number, street name, zip code, city, state, account number, FICO score, credit limit, age, month of balances, balances, etc. The feature vector generator 118 can retrieve the values by identifying the attributes in memory that have a stored association with an identifier of the account and retrieving the values for the identified attributes. In some embodiments, the feature vector generator 118 can request the values from the data source 108.

In one example, the feature vector generator 118 can retrieve the transaction data and the values for the attributes using a look-up technique in memory. For example, the feature vector generator 118 can use a look-up technique using an identifier of the account and retrieve any values of attributes and/or values of transactions within a time period that correspond to a matching identifier in memory.

In some embodiments, the feature vector generator 118 can retrieve values for transactions and/or attributes of an account in response to a trigger. A trigger may be any trigger that causes the feature vector generator 118 to calculate attrition values for accounts stored in memory. Triggers may be stored rules in memory of the feature vector generator 118 that, upon being satisfied, cause the feature vector generator 118 to evaluate one or more accounts. In some embodiments, the feature vector generator 118 may evaluate the different rules of the triggers over time and/or each time the feature vector generator 118 adds an account to memory. In some embodiments, the feature vector generator 118 can retrieve values for transactions and/or attributes of an account in response to receiving a request (e.g., a request from the client device 102 or the retention manager 110) for an account prediction value for the account. Upon detecting a trigger, the feature vector generator 118 may retrieve values for transactions and/or attributes for a specific account associated with the trigger (e.g., an account identified in a request) or for each or a subset of the accounts stored in memory.

The feature vector generator 118 may generate feature vectors. The feature vector generator 118 can generate a first feature vector (e.g., a transaction feature vector) from the values of the transactions the feature vector generator 118 retrieved for the account. For example, the feature vector generator 118 may generate the first feature vector by inserting values for different transactions into index values with timestamps that correspond to the transactions with which the values are associated (e.g., labeling the values for transactions with the timestamps that indicate when the transactions occurred). The feature vector generator 118 may group values together in the feature vector based on the timestamps (e.g., as a data timeseries) such that a recurrent machine learning model (e.g., a recurrent neural network) may receive and process the feature vector. When inserting the values into the feature vector, the feature vector generator 118 may insert all or a defined subset of the retrieved values for the transactions. In some embodiments, the feature vector generator 118 may only insert values for the timestamp, value (e.g., amount), category, merchant, and/or fees of each transaction into the feature vector.

The feature vector generator 118 can generate a second feature vector (e.g., an attribute feature vector). The feature vector generator 118 can generate the second feature vector using the retrieved values of attributes for the account. The feature vector generator 118 can do so by inserting the retrieved values of attributes into index values (e.g., defined index values) of the second feature vector. For example, the feature vector generator 118 can insert a value for the FICO score for the account into an index value that corresponds to FICO scores, a value for the credit limit for the account into an index value that corresponds to credit limits, a value for the age of the account and/or the individual associated with the account into an index value that corresponds to age, a value for the balance of the account into an index value that corresponds to account balances, etc. The feature vector generator 118 may insert any number values of attributes (e.g., attribute values) into the second feature vector.

The model manager 120 may comprise programmable instructions that, upon execution, cause the processor 114 to insert the generated feature vectors into the machine learning model 122 and execute the machine learning model 122 to generate account prediction values. The machine learning model 122 may be or include any number of machine learning models of any type (e.g., a neural network, a support vector machine, random forest, etc.). In some embodiments, the machine learning model is a dual-stage machine learning model that includes one or more encoders that generate embeddings based on feature vectors and one or more sets of prediction layers that generate account prediction values based on a concatenation of the output embeddings of the encoders.

For example, the model manager 120 can insert feature vectors into encoders of the machine learning model 122. The machine learning model 122 may include multiple encoders that are trained to receive feature vectors containing different types of data. For example, the machine learning model 122 may include a first encoder. The first encoder may be configured to receive feature vectors that include values grouped by transaction and organized by timestamp with a timeseries structure. The first encoder may be or include a recurrent machine learning model (e.g., a recurrent neural network, a long short-term memory (LSTM) neural network, or a gated recurrent unit (GRU) neural network). In some embodiments, the first encoder may include a timeseries recurrent neural network, such as a dual-stage attention-based recurrent neural network (e.g., a DA-RNN), or a Time2Vec model. In some embodiments, the first encoder may be or include one or more transformers. The feature vector generator 118 may insert the first feature vector containing timeseries data for transactions for the account into the first encoder. The feature vector generator 118 may execute the first encoder to output an embedding (e.g., a transaction embedding) for the account based on the first feature vector.

The machine learning model 122 may include a second encoder. The second encoder may be configured to receive a feature vector containing values of attributes of accounts. The second encoder may be or include a neural network, a deep neural network, an auto-encoder (e.g., a variational auto-encoder), etc. In some embodiments, the second encoder may be or include a support vector machine, random forest, etc. The second encoder may be or include any type of machine learning model. The feature vector generator 118 may insert the second feature vector containing the values of attributes of the account into the second encoder. The feature vector generator 118 may execute the second encoder to output an embedding (e.g., an attribute embedding) for the account based on the values of attributes of the account.

In some embodiments, the machine learning model 122 may include a third encoder. The third encoder may be a recurrent machine learning model similar to the first encoder or a machine learning model similar to the second encoder. The third encoder may be configured to receive a feature vector containing values for identifications of events and/or timestamps indicating times or days in which the events occurred. Events may be events (e.g., non-transaction-based events) that may occur with an account, such as an opening or closing of the account, a freezing of the account, an overdraft of the account, exceeding the credit limit of the account, a connection of the account with another account, etc. Each event may correspond to a numerical value that the feature vector generator 118 can retrieve from memory for the account and insert into index values or otherwise concatenate into a feature vector. The feature vector generator 118 may retrieve values and/or timestamps for events for the account from memory, generate a feature vector from the retrieved values and/or timestamps, and insert the feature vector into the third encoder to generate an embedding (e.g., an event embedding). The machine learning model 122 may include any number of encoders that can receive feature vectors to generate embeddings. The encoders may generate embeddings from any type of data.

The model manager 120 may concatenate the embeddings from the encoders. The model manager 120 may retrieve the transaction embedding from the first encoder and the attribute embedding from the output of the second encoder. In some embodiments, the model manager 120 may retrieve the embeddings from each encoder that generated an embedding for the account (e.g., the transaction embedding, the attribute embedding, and/or the event embedding). In some embodiments, the model manager 120 can concatenate the embeddings by generating a string or vector with values from one of the embeddings after values of another of the embeddings. The model manager 120 can concatenate the embeddings together to generate or create a concatenated embedding. The model manager 120 may be placed in any order. In this way, the model manager 120 can generate a representation of the account based on different types of data (e.g., timeseries data and non-timeseries or static data) that can be used to determine an account prediction value for the account.

The model manager 120 may determine whether the machine learning model 122 includes multiple sets of prediction layers. The model manager 120 may determine whether the machine learning model 122 includes multiple sets of prediction layers by identifying identifications of the sets of prediction layers in an application containing the machine learning model 122. The model manager 120 may maintain and increment a counter for each set of prediction layers identification the model manager 120 identifies. The model manager 120 may determine the machine learning model 122 includes multiple sets of prediction layers if the count of the counter exceeds one. Otherwise, the model manager 120 may determine the machine learning model 122 only includes one set of prediction layers.

In some embodiments, the model manager 120 may determine whether the machine learning model 122 includes multiple sets of prediction layers based on a user input or a value in a request. For example, the model manager 120 may receive a request or a user input defining one or more specific account prediction values to generate. Such account prediction values may be or include binary attrition classification values (e.g., values indicating attrition is likely and unlikely), a regression attrition value (e.g., a single value indicating a likelihood of attrition), a spending delta, next most frequent spending category, intelligent cash forecasting (e.g., how much a customer will spend in the future), etc. Each of such account prediction values may correspond to (e.g., be generated by) a set of prediction layers of the machine learning model 122 upon execution of the set of prediction layers. The model manager 120 may identify the types of account prediction values from the user input or the request. The model manager 120 may maintain and increment a counter for each identification in the request. The model manager 120 may determine the machine learning model 122 includes multiple sets of prediction layers if the count of the counter exceeds one. Otherwise, the model manager 120 may determine the machine learning model 122 only includes one set of prediction layers.

Responsive to determining the machine learning model 122 only includes one set of prediction layers in the machine learning model 122 or to only generate one account prediction value, the model manager 120 generates an account prediction value. The model manager 120 may do so by inserting or propagating the concatenated embedding into a set of prediction layers (e.g., a machine learning model 122, such as a neural network with a single or multiple fully connected layers) corresponding to the account prediction value. For example, if the machine learning model 122 only includes one set of prediction layers in the machine learning model 122, the model manager 120 may retrieve the set of prediction layers from memory and insert the concatenated embedding into the retrieved set of prediction layers. If the model manager 120 identifies the set of prediction layers based on an identification in a user input or a request, the model manager 120 may identify the set of prediction layers from memory based on the set of prediction layers corresponding to an identification in memory that matches the identification in the user input or the request (e.g., by using the identification of the set of prediction layers from the user input or request in a look-up technique in memory). The model manager 120 may retrieve the identified set of prediction layers from memory and insert the concatenated embedding into the retrieved set of prediction layers. The model manager 120 may execute the set of prediction layers to generate the account prediction value.

Responsive to determining the machine learning model 122 includes multiple sets of prediction layers or to generate multiple account prediction values the model manager 120 generates multiple account prediction values. The model manager 120 may do so by inserting or propagating the concatenated embedding into each of the sets of prediction layers of the machine learning model 122 or a subset of the sets of prediction layers the model manager 120 selects based on the user input or identifications in the request. For example, if the model manager 120 is configured to generate account prediction values for each set of prediction layers of the machine learning model 122, the model manager 120 may retrieve each set of prediction layers from memory and insert the concatenated embedding into each of the retrieved sets of prediction layers. If the model manager 120 identifies a subset of sets of prediction layers based on a user input or identifications included in a request, the model manager 120 may identify the sets of prediction layers from memory based on the sets of prediction layers corresponding to identifications in memory that match the identifications in the user input or the request (e.g., using the identification of the set of prediction layers from the user input or request in a look-up technique in memory). The model manager 120 may retrieve the identified sets of prediction layers from memory and insert the concatenated embedding into the retrieved sets of prediction layers. The model manager 120 may execute the sets of prediction layers to generate the account prediction values.

In one example, the model manager 120 may insert or propagate the concatenated embedding into at least a regression set of prediction layers and a classification set of prediction layers. The regression set of prediction layers may be configured to output a single value on a set scale (e.g., 1-100) indicating a likelihood of attrition of the account. The classification set of prediction layers may be configured to output values for multiple classifications (e.g., a value indicating a likelihood of attrition of the account and a value indicating a likelihood that the account will not satisfy the attrition requirements). The model manager 120 may execute the regression set of prediction layers and classification set of prediction layers to obtain a regression value indicating a regression likelihood of attrition of the account from the regression set of prediction layers and first and second classification values indicating, respectively, a classification likelihood of attrition and a likelihood that the account will not satisfy the attrition requirements (e.g., a likelihood that the account will not be involved in individual or an aggregate of transaction with values that exceed a threshold within a time period).

The model manager 120 may determine if the concatenated embedding is being used to train the machine learning model 122. The model manager 120 may determine if the concatenated embedding is being used to train the machine learning model 122 based on a user input or request or a setting or configuration of the machine learning model 122. For example, in instances in which the model manager 120 receives a request to generate an account prediction value or account prediction values for an account, the request may also include a request to train the machine learning model 122 based on the generated account prediction values. If the model manager 120 identifies a request for training in the request, the model manager 120 may determine to train the machine learning model 122 using the concatenated embedding. Otherwise, the model manager 120 may determine not to train the machine learning model 122 with the concatenated embedding.

In another example, the model manager 120 may determine to train the machine learning model 122 using the concatenated embedding based on a user input (e.g., a selection of a form box) indicating whether or not to train the machine learning model 122. For instance, the model manager 120 may receive a user input to train the machine learning model 122 using training data (e.g., a series of transactions and account attributes for accounts stored in memory of the model manager 120), including the data used to generate the concatenated embedding. Based on the user input, the model manager 120 may generate feature vectors from the training data to input into the encoders to generate concatenated embeddings for individual accounts. The model manager 120 may determine to use the concatenated embeddings to train the machine learning model 122 based on the user input indicating to train the machine learning model 122 based on the concatenated embeddings. In another example, the model manager 120 may determine whether or not to train the machine learning model 122 based on the concatenated embedding by identifying a setting or configuration indicating whether to train the machine learning model 122 using the concatenated embedding.

Responsive to determining to use the concatenated embedding to train the machine learning model 122, the model manager 120 trains the encoders and/or sets of prediction layers of the machine learning model 122 using the concatenated embedding. To do so, in instances in which the model manager 120 only generates one account prediction value from one set of prediction layers, the model manager 120 can label the concatenated embedding with a correct or ground truth value for the account prediction value. The model manager 120 may then use back-propagation techniques according to a loss function to train the set of prediction layers that generated the account prediction value. In some embodiments, the model manager 120 may further propagate the changes through to the encoders according to the loss function or a different loss function. In this way, the model manager 120 may train the encoders and/or set of prediction layers based on the label and account prediction value generated by the set of prediction layers.

In instances in which the model manager 120 generates multiple account predictions values with multiple sets of prediction layers, the model manager 120 can mirror or copy the concatenated embedding into multiple concatenated embeddings (e.g., a number of concatenated embeddings equal to the number of sets of prediction layers the model manager 120 identifies, retrieves, and/or selects to generate account prediction values) with the same values as the concatenated embedding (e.g., the original concatenated embedding). The model manager 120 may then label each concatenated embedding with a correct or ground truth value for an account prediction value that corresponds to the set of prediction layers that the labeled concatenated embedding will be used to train. The model manager 120 may then separately train (e.g., using back-propagation techniques) each set of prediction layers using the labeled concatenated embedding that corresponds to the respective set of prediction layers. The model manager 120 may further train (e.g., using back-propagation techniques) the encoders based on each labeled concatenated embedding, thus training the encoders and sets of prediction layers to accurately generate different types of account prediction values.

Responsive to the model manager 120 determining not to use the concatenated embedding to train the machine learning model 122, the model manager 120 may determine whether to determine or select a retention action. The model manager 120 may determine whether to determine or select a retention action based on a user input, identification in a request, a configuration, or a setting. For example, in instances in which the model manager 120 receives a request to generate an account prediction value or account prediction values for an account, the request may also include a request to determine or select a retention action. In such cases, the model manager 120 may determine to determine or select a retention action. Otherwise, the model manager 120 may determine not to determine or select a retention action.

In another example, the model manager 120 may receive a user input (e.g., a selection of a form checkbox) indicating whether to determine or select a retention action. The model manager 120 may determine whether to determine or select a retention action based on the user input. In another example, the model manager 120 may store a configuration or setting that causes the model manager 120 to automatically determine or select a retention action. The model manager 120 may determine whether to determine or select a retention action based on whether the model manager 120 has such a configuration or setting.

Responsive to deciding whether to determine or select a retention action, the action selector 124 may retrieve one or more retention action rules. The action selector 124 may comprise programmable instructions that, upon execution, cause the processor 114 to apply action retention rules to the output account prediction values to select retention actions. Retention action rules may be rules with criteria that indicate whether to determine or select a retention action and/or which retention action to select. The criteria of the rules may be satisfied based on the account prediction values from the sets of prediction layers of the machine learning model 122. For example, a retention action rule may indicate to select a retention action for an account responsive to an account prediction value indicating a likelihood of attrition (e.g., a regression likelihood of attrition or a positive attrition value of a classification account prediction value) exceeds a threshold (e.g., an attrition threshold). Another retention action rule may indicate to select a retention action responsive to multiple account prediction values satisfying criteria or a pattern of the retention action rule. For instance, a retention action rule may be satisfied if an account prediction value indicating a likelihood of attrition exceeds a threshold and a predicted account balance is less than another threshold (e.g., a balance threshold). In another instance, a retention action rule may be satisfied if the action selector 124 applies a retention action rule or a pattern to a regression value and one or both classification values for a likelihood of attrition and determine the values satisfy the rule or pattern (e.g., the values are each within a range or ranges and/or above a threshold or thresholds of the retention action rule or pattern). Retention action rules may include any such criteria and may be based on any combination of account prediction values.

The action selector 124 may retrieve the retention action rules from memory. For example, the action selector 124 may retrieve the retention action rules from a database that stores retention action rules. In some embodiments, the action selector 124 may retrieve the retention action rules from a remote computer or database that stores retention action rules. The retention action rules may be or include strings of code (e.g., “if-then” statements) or one or more files that contain such retention action rules.

The action selector 124 can apply the one or more retention action rules to the generated account prediction value or account prediction values. The action selector 124 may apply the one or more retention action rules to the account prediction value or account prediction values by comparing the account prediction value or account prediction values to the one or more retention action rules. For example, the action selector 124 may apply if-then statements or other criteria of the retention action rules to the generated account prediction value or account prediction values and determine which, if any, retention action rules are satisfied. Responsive to the action selector 124 determining there are not any retention action rules that are satisfied (e.g., the likelihood of attrition for the account is low or below a threshold), the action selector 124 may generate and/or transmit an alert or message to an administrator computing device indicating no retention action is necessary for the account.

The action selector 124 can select a retention action. Retention actions can be actions that can be used or implemented to attempt to retain accounts or individual that may stop using an organization's products. For example, retention actions may include sending a predetermined email, phone call, text message, or other electronic communication to an individual associated with the account for which the retention action was selected. In some embodiments, retention actions may be real world actions such as mailing a letter. In some embodiments, a retention action may an action to automatically update the account with incentives (e.g., deals) to remain a customer of the organization. Retention actions may be any action.

The action selector 124 may select a retention action that corresponds to the retention action rule that is satisfied. For example, different retention action rules may correspond to different retention actions. The action selector 124 may identify the retention action rule that is satisfied and identify a retention action that has a stored association with the retention action rule in memory. The action selector 124 may retrieve the identified retention action based on the association the retention action has with the satisfied retention action rule.

In another example, a retention action rule may correspond to different retention actions depending on which criteria of the retention action rule were satisfied. For instance, a retention action rule may have multiple thresholds for an account prediction value (e.g., a threshold for likelihood of attrition of 25%, 50%, and 75%). Each threshold may correspond to a different retention action. The action selector 124 may identify which threshold or thresholds a likelihood of attrition of the account satisfies and select the retention action that corresponds to the satisfied threshold. Similarly, for a rule with criteria for multiple account prediction values. Different combinations of criteria or thresholds for the account prediction values may correspond to different retention actions. The action selector 124 may identify the combination of criteria or thresholds that account prediction values for the account satisfy and identify and select a retention action that corresponds to the combination. The retention actions may correspond to a likelihood of retaining the account based on the rule or rules that are satisfied. In this way, the action selector 124 may use a combination of rules and the architecture of the machine learning model 122 to select a retention action that has an optimal chance of retaining the account.

The action selector 124 may generate a record (e.g., a file, document, table, listing, message, notification, etc.). The action selector 124 may generate the record by including any account prediction values the machine learning model output and/or the retention action the action selector 124 selected, if any, in the record. The action selector 124 may include the account prediction values and/or the retention action in the record by inserting the account prediction values and/or the retention action into the record as a string of text containing the retention action and/or the account prediction values. In instances in which the action selector 124 determines not to determine or select a retention action, the action selector 124 may only include any generated account prediction values in the record.

The transmitter 126 may comprise programmable instructions that, upon execution, cause the processor 114 to apply transmit and/or receive messages with computers such as the client device 102, the data source 108, or the retention manager 110. The transmitter 126 may be or include an application programming interface (API) that enables communication across the network 106. The transmitter 126 may transmit the record to the retention manager 110. In doing so, the transmitter 126 may transmit the record to a remote computing device that is accessed by an administrator that may view the record on a user interface. The administrator may view the account prediction value or values and/or the retention action and determine whether to implement the retention action or execute another retention action.

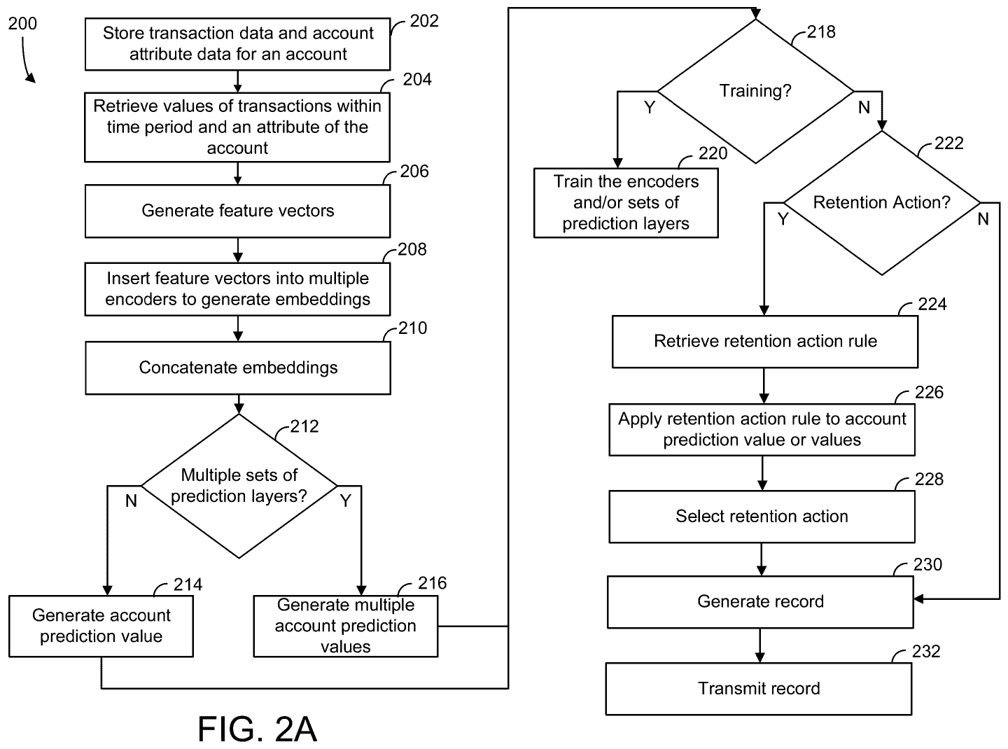

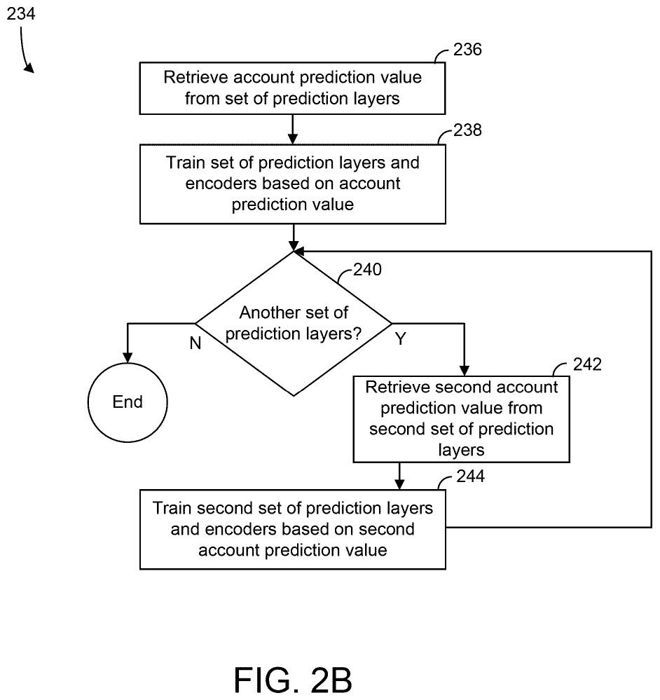

FIG. 2A is an illustration of a method for attrition prediction, in accordance with an implementation. The method 200 can be performed by a data processing system (a client device or an attrition prediction engine 104, shown and described with reference to FIG. 1, a server system, etc.). The method 200 may include more or fewer operations and the operations may be performed in any order. Performance of the method 200 may enable the data processing system to account for transactions performed over time using a machine learning architecture to predict attrition of accounts associated with the transactions. The data processing system may implement a machine learning architecture with two encoders: one encoder configured to receive feature vectors of transaction data associated with different times (e.g., transactions associated with timestamps indicating when the transactions occurred), and another encoder that is configured to receive feature vectors that include attributes of accounts. For an account, the data processing system may generate a feature vector of transaction data of transactions corresponding to the account performed over a time period and a feature vector of attributes of the account. The data processing system may input the feature vector of transaction data into the encoder configured to process transaction data and the feature vector of attributes (e.g., attribute values of attributes) for the account into the encoder configured to process attribute data of accounts. The data processing system may concatenate embeddings that each encoder generates based on the respective feature vectors. The data processing system may input the concatenated embedding into a set of prediction layers to generate an account prediction value indicating a likelihood of attrition for the account (or another type of account prediction value). In this way, the data processing system may implement a machine learning architecture to calculate an account prediction value for an account taking into account both attributes for the account and transaction data from transactions performed by or through the account over time.

At operation 202, the data processing system stores transaction data and account attribute data for accounts. The accounts may include attribute-value pairs that each include a different attribute and a value for the attribute. For example, the account may include attribute-value pairs for first name, last name, full name, address, phone number, cell phone number, home phone number, tax identification number, street name, zip code, city, state, account number, FICO score, credit limit, age, month of balances, balances, etc. The data processing system may additionally store data for transactions performed through or by the different accounts in the database. Each stored transaction may include data about the transaction such as a time the transaction took place, a category (e.g., a category of an item purchased on the transaction, such as groceries, leisure, travel, sporting event, food, vehicle, housing, etc.), a location of the transaction, a value (e.g., amount) of the transaction, a merchant (e.g., the entity with which the transaction took place) of the transaction, fees associated with the transaction, etc. The data processing system may store the data for each transaction with associations with the accounts that correspond to or that were otherwise used to perform the transactions.

At operation 204, the data processing system retrieves values of transactions performed by an account and an attribute of the account. In retrieving the values of the transactions, the data processing system may retrieve values such as timestamps indicating the times and/or days the transactions took place, categories of the transactions, locations of the transactions, values of the transactions, merchants of the transactions, fees associated with the transactions, etc. The data processing system may retrieve the values for the transactions by retrieving values for transactions that were performed within a time period. The time period may be a defined length of time previous to the current time or a reference time or another time defined time relative to the current time or a reference time. The data processing system may retrieve the values from memory or a database by identifying timestamps associated with transactions that fall within the time period and retrieving the values that correspond to the transactions of the identified timestamps. The data processing system may retrieve the values of transactions for the account by retrieving values for transactions that are associated with the account.

The data processing system can retrieve one or more values of attributes of the account. The data processing system can retrieve the values by identifying the attributes in memory that have a stored association with an identifier of the account and retrieving the values for the identified attributes.

In one example, the data processing system can retrieve the transaction data and the values for the attributes using a look-up technique in memory. For example, the data processing system can use a look-up technique using an identifier of the account and retrieve any values of attributes and/or values of transactions within a time period that correspond to a matching identifier in memory.

In some embodiments, the data processing system can retrieve values for transactions and/or attributes of an account in response to a trigger. A trigger may be any trigger that causes the data processing system to calculate attrition values for accounts stored in memory. In some embodiments, the data processing system may evaluate the different rules of the triggers over time and/or each time the data processing system adds the account to memory. In some embodiments, the data processing system can retrieve values for transactions and/or attributes of an account in response to receiving a request for an account prediction value for the account, such as a request from a computing device. Upon detecting a trigger, the data processing system may retrieve values for transactions and/or attributes for a specific account associated with the trigger (e.g., an account identified in a request) or for each or a subset of the accounts stored in memory and proceed to operation 206.

At operation 206, the data processing system generates feature vectors. The data processing system can generate a first feature vector from the values of the transactions the data processing system retrieved for the account. For example, the data processing system may generate the first feature vector by inserting values for different transactions into index values with timestamps that correspond to the transactions with which the values are associated. The data processing system may group values together in the feature vector based on the timestamps such that a recurrent machine learning model may receive and process the feature vector. When inserting the values into the feature vector, the data processing system may insert all or a defined subset of the retrieved values for the transactions. In some embodiments, the data processing system may only insert values for the timestamp, value, category, merchant, and/or fees of each transaction into the feature vector.

The data processing system can generate a second feature vector. The data processing system can generate the second feature vector using the retrieved values of attributes for the account. The data processing system can do so by inserting the retrieved values of attributes into index values of the second feature vector. For example, the data processing system can insert a value for the FICO score for the account into an index value that corresponds to FICO scores, a value for the credit limit for the account into an index value that corresponds to credit limits, a value for the age of the account and/or the individual associated with the account into an index value that corresponds to age, a value for the balance of the account into an index value that corresponds to account balances, etc. The data processing system may insert any number values of attributes into the second feature vector.

At operation 208, the data processing system inserts feature vectors into encoders of a machine learning model. The machine learning model may include multiple encoders that are trained to receive feature vectors containing different types of data. For example, the machine learning model may include a first encoder. The first encoder may be configured to receive feature vectors that include values grouped by transaction and organized by timestamp with a timeseries structure. The first encoder may be or include a recurrent machine learning model. In some embodiments, the first encoder may include a timeseries recurrent neural network, such as a dual-stage attention-based recurrent neural network, or a Time2Vec model. In some embodiments, the first encoder may be or include one or more transformers. The data processing system may insert the first feature vector containing timeseries data for transactions for the account into the first encoder. The data processing system may execute the first encoder to output an embedding for the account based on the first feature vector.

The machine learning model may include a second encoder. The second encoder may be configured to receive a feature vector containing values of attributes of accounts. The second encoder may be or include a neural network, a deep neural network, an auto-encoder, etc. In some embodiments, the second encoder may be or include a support vector machine, random forest, etc. The second encoder may be or include any type of machine learning model. The data processing system may insert the second feature vector containing the values of attributes of the account into the second encoder. The data processing system may execute the second encoder to output an embedding (e.g., an attribute embedding) for the account based on the values of attributes of the account.

In some embodiments, the machine learning model may include a third encoder. The third encoder may be a recurrent machine learning model similar to the first encoder or a machine learning model similar to the second encoder. The third encoder may be configured to receive a feature vector containing values for identifications of events and/or timestamps indicating times or days in which the events occurred. Events may be events (e.g., non-transaction-based events) that may occur with an account, such as an opening or closing of the account, a freezing of the account, an overdraft of the account, exceeding the credit limit of the account, a connection of the account with another account, etc. Each event may correspond to a numerical value that the data processing system can retrieve from memory for the account and insert into index values or otherwise concatenate into a feature vector. The data processing system may retrieve values and/or timestamps for events for the account from memory, generate a feature vector from the retrieved values and/or timestamps, and insert the feature vector into the third encoder to generate an embedding (e.g., an event embedding). The machine learning model may include any number of encoders that can receive feature vectors to generate embeddings.

At operation 210, the data processing system concatenates the embeddings from the encoders. The data processing system may retrieve the transaction embedding from the first encoder and the attribute embedding from the output of the second encoder. In some embodiments, the data processing system may retrieve the embeddings from each encoder that generated an embedding for the account (e.g., the transaction embedding, the attribute embedding, and/or the event embedding). In some embodiments, the data processing system can concatenate the embeddings by generating a string or vector with values from one of the embeddings after values of another of the embeddings. The data processing system can concatenate the embeddings together to generate or create a concatenated embedding. The data processing system may be placed in any order. In this way, the data processing system can generate a representation of the account based on different types of data (e.g., timeseries data and non-timeseries or static data) that can be used to determine an account prediction value for the account.

At operation 212, the data processing system determines whether the machine learning model includes multiple sets of prediction layers. The data processing system may determine whether the machine learning model includes multiple sets of prediction layers by identifying identifications of the sets of prediction layers in an application containing the machine learning model. The data processing system may maintain and increment a counter for each set of prediction layers identification the data processing system identifies. The data processing system may determine the machine learning model includes multiple sets of prediction layers if the count of the counter exceeds one. Otherwise, the data processing system may determine the machine learning model only includes one set of prediction layers.

In some embodiments, the data processing system may determine whether the machine learning model includes multiple sets of prediction layers based on a user input or a value in a request. For example, the data processing system may receive a request or a user input defining one or more specific account prediction values to generate. Such account prediction values may be or include binary attrition classification values (e.g., values indicating attrition is likely and unlikely), a regression attrition value (e.g., a single value indicating a likelihood of attrition), a spending delta, next most frequent spending category, intelligent cash forecasting, etc. Each of such account prediction values may correspond to (e.g., be generated by) a set of prediction layers of the machine learning model. The data processing system may identify the types of account prediction values from the user input or the request. The data processing system may maintain and increment a counter for each identification in the request. The data processing system may determine the machine learning model includes multiple sets of prediction layers if the count of the counter exceeds one. Otherwise, the data processing system may determine the machine learning model only includes one set of prediction layers.

Responsive to determining the machine learning model only includes one set of prediction layers in the machine learning model or to only generate one account prediction value, at operation 214, the data processing system generates an account prediction value. The data processing system may do so by inserting or propagating the concatenated embedding into a set of prediction layers corresponding to the account prediction value. For example, if the machine learning model only includes one set of prediction layers in the machine learning model, the data processing system may retrieve the set of prediction layers from memory and insert the concatenated embedding into the retrieved set of prediction layers. If the data processing system identifies the set of prediction layers based on an identification in a user input or a request, the data processing system may identify the set of prediction layers from memory based on the set of prediction layers corresponding to an identification in memory that matches the identification in the user input or the request (e.g., by using the identification of the set of prediction layers from the user input or request in a look-up technique in memory). The data processing system may retrieve the identified set of prediction layers from memory and insert the concatenated embedding into the retrieved set of prediction layers. The data processing system may execute the set of prediction layers to generate the account prediction value.

Responsive to determining the machine learning model includes multiple sets of prediction layers or to generate multiple account prediction values, at operation 216, the data processing system generates multiple account prediction values. The data processing system may do so by inserting or propagating the concatenated embedding into each of the sets of prediction layers of the machine learning model or a subset of the sets of prediction layers the data processing system selects based on the user input or identifications in the request. For example, if the data processing system is configured to generate account prediction values for each set of prediction layers of the machine learning model, the data processing system may retrieve each set of prediction layers from memory and insert the concatenated embedding into each of the retrieved sets of prediction layers. If the data processing system identifies a subset of sets of prediction layers based on a user input or identifications included in a request, the data processing system may identify the sets of prediction layers from memory based on the sets of prediction layers corresponding to identifications in memory that match the identifications in the user input or the request (e.g., using the identification of the set of prediction layers from the user input or request in a look-up technique in memory). The data processing system may retrieve the identified sets of prediction layers from memory and insert the concatenated embedding into the retrieved sets of prediction layers. The data processing system may execute the sets of prediction layers to generate the account prediction values.

In one example, the data processing system may insert or propagate the concatenated embedding into at least a regression set of prediction layers and a classification set of prediction layers. The regression set of prediction layers may be configured to output a single value on a set scale (e.g., 1-100) indicating a likelihood of attrition of the account. The classification set of prediction layers may be configured to output values for multiple classifications (e.g., a value indicating a likelihood of attrition of the account and a value indicating a likelihood that the account will not satisfy attrition requirements). The data processing system may execute the regression set of prediction layers and classification set of prediction layers to obtain a regression value indicating a regression likelihood of attrition of the account from the regression set of prediction layers and first and second classification values indicating, respectively, a classification likelihood of attrition and a likelihood that the account will not satisfy the attrition requirements (e.g., a likelihood that the account will not be involved in individual or an aggregate of transactions with values that exceed a threshold within a time period).

At operation 218, the data processing system may determine if the concatenated embedding is being used to train the machine learning model. The data processing system may determine if the concatenated embedding is being used to train the machine learning model based on a user input or request or a setting or configuration of the machine learning model. For example, in instances in which the data processing system receives a request to generate an account prediction value or account prediction values for an account, the request may also include a request to train the machine learning model based on the generated account prediction values. If the data processing system identifies a request for training in the request, the data processing system may determine to train the machine learning model using the concatenated embedding. Otherwise, the data processing system may determine not to train the machine learning model with the concatenated embedding.

In another example, the data processing system may determine to train the machine learning model using the concatenated embedding based on a user input (e.g., a selection of a form box) indicating whether or not to train the machine learning model. For instance, the data processing system may receive a user input to train the machine learning model using training data (e.g., a series of transactions and account attributes for accounts stored in memory of the data processing system), including the data used to generate the concatenated embedding. Based on the user input, the data processing system may generate feature vectors from the training data to input into the encoders to generate concatenated embeddings for individual accounts. The data processing system may determine to use the concatenated embeddings to train the machine learning model based on the user input indicating to train the machine learning model based on the concatenated embeddings. In another example, the data processing system may determine whether or not to train the machine learning model based on the concatenated embedding by identifying a setting or configuration indicating whether to train the machine learning model using the concatenated embedding.

Responsive to determining to use the concatenated embedding to train the machine learning model, at operation 220, the data processing system trains the encoders and/or sets of prediction layers of the machine learning model using the concatenated embedding. To do so, in instances in which the data processing system only generates one account prediction value from one set of prediction layers, the data processing system can label the concatenated embedding with a correct or ground truth value for the account prediction value. The data processing system may then use back-propagation techniques according to a loss function to train the set of prediction layers that generated the account prediction value. In some embodiments, the data processing system may further propagate the changes through to the encoders according to the loss function or a different loss function. In this way, the data processing system may train the encoders and/or set of prediction layers based on the label and account prediction value generated by the set of prediction layers.

In instances in which the data processing system generates multiple account predictions values with multiple sets of prediction layers, the data processing system can mirror or copy the concatenated embedding into multiple concatenated embeddings with the same values as the concatenated embedding (e.g., the original concatenated embedding). The data processing system may then label each concatenated embedding with a correct or ground truth value for an account prediction value that corresponds to the set of prediction layers the labeled concatenated embedding will be used to train. The data processing system may then separately train (e.g., using back-propagation techniques) each set of prediction layers using the labeled concatenated embedding that corresponds to the respective set of prediction layers. The data processing system may further train (e.g., using back-propagation techniques) the encoders based on each labeled concatenated embedding. Details about how the machine learning model may be trained are included with reference to FIG. 2B.

Responsive to the data processing system determining not to use the concatenated embedding to train the machine learning model, at operation 222, the data processing system may determine whether to determine or select a retention action. A retention action may be an action a business or organization may take to retain an account that has a high likelihood (e.g., a likelihood above a threshold or a likelihood that satisfies one or more retention action rules) of attrition. The data processing system may determine whether to determine or select a retention action based on a user input, identification in a request, a configuration, or a setting. For example, in instances in which the data processing system receives a request to generate an account prediction value or account prediction values for an account, the request may also include a request to determine or select a retention action. In such cases, the data processing system may determine to determine or select a retention action. Otherwise, the data processing system may determine not to determine or select a retention action.

In another example, the data processing system may receive a user input (e.g., a selection of a form checkbox) indicating whether to determine or select a retention action. The data processing system may determine whether to determine or select a retention action based on the user input. In another example, the data processing system may store a configuration or setting that causes the data processing system to automatically determine or select a retention action. The data processing system may determine whether to determine or select a retention action based on whether the data processing system has such a configuration or setting.

Responsive to deciding whether to determine or select a retention action, at operation 224, the data processing system retrieves one or more retention action rules. Retention action rules may be rules with criteria that indicate whether to determine or select a retention action and/or which retention action to select. The criteria of the rules may be satisfied based on the account prediction values from the sets of prediction layers of the machine learning model. For example, a retention action rule may indicate to select a retention action for an account responsive to an account prediction value indicating a likelihood of attrition (e.g., a regression likelihood of attrition or a “yes” attrition value of a classification account prediction value) exceeds a threshold (e.g., an attrition threshold). Another retention action rule may indicate to select a retention action responsive to multiple account prediction values satisfying criteria or a pattern of the retention action rule. For instance, a retention action rule may be satisfied if an account prediction value indicating a likelihood of attrition exceeds a threshold and a predicted account balance is less than another threshold (e.g., a balance threshold). In another instance, a retention action rule may be satisfied if the data processing system applies a retention action rule or a pattern to a regression value and one or both classification values for a likelihood of attrition and determine the values satisfy the rule or pattern (e.g., the values are each within a range or ranges and/or above a threshold or thresholds of the retention action rule or pattern). Retention action rules may include any such criteria and may be based on any combination of account prediction values.

The data processing system may retrieve the retention action rules from memory. For example, the data processing system may retrieve the retention action rules from a database that stores retention action rules. In some embodiments, the data processing system may retrieve the retention action rules from a remote computer or database that stores retention action rules. The retention action rules may be or include strings of code or one or more files that contain such retention action rules.

At operation 226, the data processing system applies the one or more retention action rules to the generated account prediction value or account prediction values. The data processing system may apply the one or more retention action rules to the account prediction value or account prediction values by comparing the account prediction value or account prediction values to the one or more retention action rules. For example, the data processing system may apply if-then statements or other criteria of the retention action rules to the generated account prediction value or account prediction values and determine which, if any, retention action rules are satisfied. Responsive to the data processing system determining there are not any retention action rules that are satisfied (e.g., the likelihood of attrition for the account is low or below a threshold), the data processing system may generate and/or transmit an alert or message to an administrator computing device indicating no retention action is necessary for the account. In such cases, the data processing system may stop performing the method 200.

Otherwise, at operation 228, the data processing system selects a retention action. The data processing system may select a retention action that corresponds to the retention action rule that is satisfied. For example, different retention action rules may correspond to different retention actions. The data processing system may identify the retention action rule that is satisfied and identify a retention action that has a stored association with the retention action rule in memory. The data processing system may retrieve the identified retention action based on the association the retention action has with the satisfied retention action rule.

In another example, a retention action rule may correspond to different retention actions depending on which criteria of the retention action rule were satisfied. For instance, a retention action rule may have multiple thresholds for an account prediction value (e.g., a threshold for likelihood of attrition of 25%, 50%, and 75%). Each threshold may correspond to a different retention action. The data processing system may identify which threshold or thresholds a likelihood of attrition of the account satisfies and select the retention action that corresponds to the satisfied threshold. Similarly, for a rule with criteria for multiple account prediction values. Different combinations of criteria or thresholds for the account prediction values may correspond to different retention actions. The data processing system may identify the combination of criteria or thresholds that account prediction values for the account satisfy and identify and select a retention action that corresponds to the combination. The retention actions may correspond to a likelihood of retaining the account based on the rule or rules that are satisfied. In this way, the data processing system may use a combination of rules and the architecture of the machine learning model to select a retention action that has an optimal chance of retaining the account.

At operation 230, the data processing system generates a record. The data processing system may generate the record by including any account prediction values the machine learning model output and/or the retention action the data processing system selected, if any, in the record. The data processing system may include the account prediction values and/or the retention action in the record by inserting the account prediction values and/or the retention action into the record as a string of text containing the retention action and/or the account prediction values. In instances in which the data processing system determines, at operation 222, not to determine or select a retention action, the data processing system may only include any generated account prediction values in the record.

At operation 232, the data processing system may transmit the record to a remote computing device. In doing so, the data processing system may transmit the record to a remote computing device that is accessed by an administrator that may view the record on a user interface. The administrator may view the account prediction value or values and/or the retention action and determine whether to implement the retention action or execute another retention action.

FIG. 2B is an illustration of a method 234 for training a model for attrition prediction, in accordance with an implementation. The method 234 can be performed by a data processing system (e.g., a client device 102, the model manager 120, or the attrition prediction engine 104, shown and described with reference to FIG. 1, a server system, etc.). The method 234 may include more or fewer operations and the operations may be performed in any order. One or more of the operations of the method 234 may be performed during or as operation 220, shown and described with reference to FIG. 2A. Performance of method 234 may enable the data processing system to train a single- or multi-set of prediction layers machine learning model to implement the systems and methods described herein to generate account prediction values and/or select retention accounts for an account.

At operation 236, the data processing system retrieves an account prediction value from a set of prediction layers of a machine learning model. The machine learning model may contain or include the set of prediction layers, a first encoder for transaction data (e.g., the first encoder described with reference to FIG. 2A), and a second encoder for attribute data (e.g., the second encoder described with reference to FIG. 2A). The account prediction value may be generated by the set of prediction layers of the machine learning model from a concatenated embedding. The concatenated embedding may be generated by the data processing system from embeddings output by the first and second encoders from transaction data and attribute data of an account, as described herein. The data processing system may retrieve the account prediction value after the set of prediction layers generates the account prediction value.

At operation 238, the data processing system trains the set of prediction layers and the encoders of the machine learning model. The data processing system may train the set of prediction layers and the encoders based on the account prediction value generated by the set of prediction layers. The data processing system may train the set of prediction layers and the encoders according to a loss function using back-propagation techniques. For example, the data processing system may label the concatenated feature the set of prediction layers used to generate the account prediction value with a correct or ground truth value. The data processing system may compare the account prediction value output by the set of prediction layers with the correct or ground truth value to determine a difference between the two values. The data processing system may use back-propagation techniques on the set of prediction layers and/or the encoders based on the difference to adjust the weights or parameters of the set of prediction layers and the encoders. In this way, the data processing system may use the output of the set of prediction layers to train both the set of prediction layers and the encoders of the machine learning model.

At operation 240, the data processing system may determine if another set of prediction layers generated an account prediction value based on the same concatenated embedding. For example, the data processing system may generate a copy of the concatenated embedding for each set of prediction layers of the machine learning model or a subset of the sets of prediction layers of the machine learning model as described herein. The data processing system may label each of the copies of the concatenated embedding with correct or ground truth values (which the data processing system may retrieve from memory and/or from a user input) for the sets of prediction layers for which the copies of the concatenated embedding were generated. The data processing system may execute each of the sets of prediction layers with respective copies of the concatenated embeddings to generate output account prediction values for the sets of prediction layers. After training the set of prediction layers and encoders of the machine learning model based on an account prediction value from one set of prediction layers, the data processing system may query the outputs of any other sets of prediction layers (if any) of the machine learning model to determine if another set of prediction layers generated an account prediction value from the concatenated embedding. Responsive to determining no other sets of prediction layers generated an account prediction value, the data processing system may stop performing the method 234.

However, responsive to determining a second set of prediction layers (e.g., another set of prediction layers) generated an account prediction value, at operation 242, the data processing system retrieves a second account prediction value from the second set of prediction layers. The data processing system may retrieve the second account prediction value from the output (e.g., the output node of a neural network) of the second set of prediction layers. At operation 244, the data processing system trains the second set of prediction layers and the encoders of the machine learning model. The data processing system may train the second set of prediction layers by comparing the second account prediction value from the second set of prediction layers to the label of the concatenated embedding that was inserted into the second set of prediction layers to generate the second account prediction value. The data processing system may then use a loss function based on the difference and back-propagation techniques to change the weights and/or parameters of the second set of prediction layers and the encoders. The data processing system may repeat operations 240-244 for each set of prediction layers of the machine learning model that generated an account prediction value based on the concatenated embedding (e.g., based on copies of the concatenated embedding). In this way, the data processing system may iteratively train the machine learning model, tuning each set of prediction layers to generate different types of account prediction values. The data processing system may do so while training each of the encoders to improve the accuracy of the encoders to generate accurate embeddings that can be inserted into each set of prediction layers.

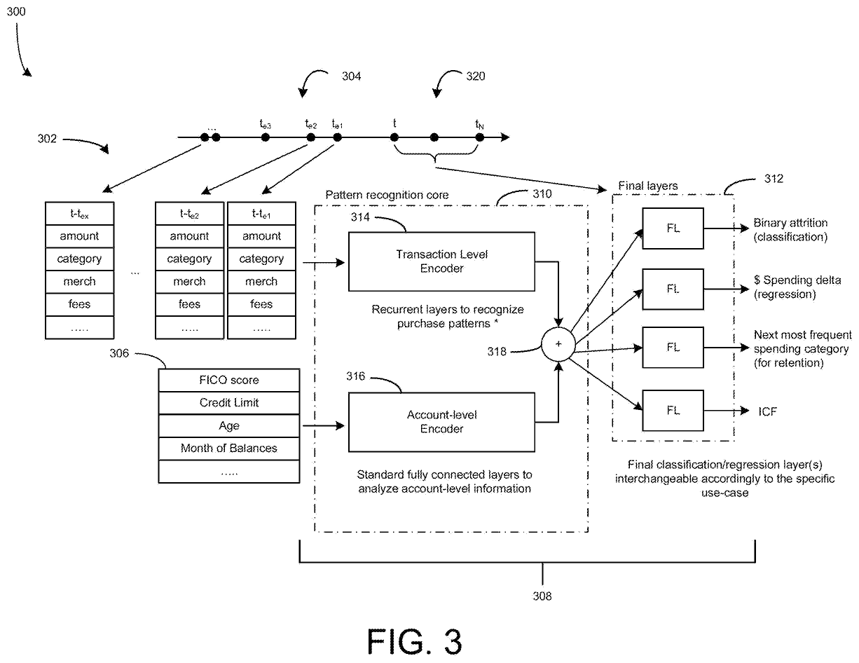

FIG. 3 is an illustration of a sequence 300 for executing a model for attrition prediction of an account, in accordance with an implementation. The sequence 300 may include operations that are performed by a data processing system (e.g., the client device 102 or the attrition prediction engine 104, shown and described with reference to FIG. 1, a server system, etc.). The sequence 300 may include more or fewer operations and the operations may be performed in any order.

In the sequence 300, the data processing system may generate a first feature vector 302 of transaction timeseries data for an account. The data processing system may generate the first feature vector 302 using data from transactions 304 that correspond to the account performed during a defined time period (e.g., a time period having a defined length before the current time). The first feature vector 302 may include a timeseries sequence of transactions with timestamps that indicate the times or days in which the transactions occurred.

The data processing system may also generate a second feature vector 306. The data processing system may generate the second feature vector using values of attributes for the account. Such attribute values may include a FICO score, a credit limit, an age, a month of balances, etc. The data processing system may concatenate the values together or insert values into index values of the second feature vector to generate the second feature vector.

The data processing system may insert the first and second feature vectors into separate encoders of a machine learning model 308. The machine learning model 308 may be or include a dual-core machine learning model with a pattern recognition core 310 and/or a final layers core 312. The pattern recognition core 310 may include one or more encoders that are each trained to receive feature vectors with different types of data to generate embeddings. For example, the pattern recognition core 310 may include a transaction level encoder 314 and an account level encoder 316. The transaction level encoder 314 may be a recurrent machine learning model configured to process (e.g., apply weights and/or parameters) values of timeseries feature vectors of transaction data for different accounts to generate embeddings. The account level encoder 316 may be a machine learning model configured to process account attribute values of feature vectors (e.g., non-timeseries feature vectors) to generate embeddings. The transaction level encoder 314 may receive and process the first feature vector 302 and the account level encoder 316 may receive and process the second feature vector 306.

The transaction level encoder 314 and the account level encoder 316 may each output an embedding (e.g., a numerical vector). Through the pattern recognition core 310, at 318, the data processing system may concatenate the embeddings output from the transaction level encoder 314 and the account level encoder 316 to generate a concatenated embedding. The data processing system may feed the concatenated embedding to the sets of prediction layers of the final layer core 312 (e.g., a neural network or other machine learning model) to generate account prediction values (e.g., one or more binary attrition classification values, a spending delta regression value, a most frequent spending category, an intelligent cash forecast, etc.).

In some embodiments, the data processing system may use transactions 320 performed in a post period (e.g., a time period subsequent to the time period in which the transactions 304 were performed) to train the encoders and sets of prediction layers of the machine learning model 308. For example, if attrition is defined as a customer spending less than a threshold amount of money within a defined time period (e.g., within the next month), the data processing system may collect and identify the data from the transactions 320 to identify the amount of money the customer spent within the time period subsequent to the time period in which the transactions 304 were performed. The data processing system may aggregate the values of the transactions 320 to obtain an aggregated value. The data processing system may compare the aggregated value to the threshold to determine if the amount exceeds the threshold. The data processing system may label the concatenated feature vector based on whether the aggregated value exceeds the threshold (e.g., if the aggregated value exceeds the threshold, the data processing system may label the feature vector with a flag indicating there is a low likelihood of attrition and/or if the aggregated value is less than the threshold, the data processing system may label the feature vector with a flag indicating there is a high likelihood of attrition). The data processing system may then use the labeled feature vector to train a regression or classification set of prediction layers configured to predict likelihoods of attrition of accounts.

In another example, the data processing system may analyze the transactions 320 to determine a label for a set of prediction layers configured to generate an account prediction value for a spending delta. For example, the data processing system may aggregate the values of the transactions 304 to calculate a pre-period spend of the account and aggregate the values of the transactions 320 to calculate a post-period spend of the account. The data processing system may subtract one of the aggregated values from the other aggregated value to calculate a spending delta between the two periods. The data processing system may label the concatenated feature vector (e.g., a copy of the concatenated feature vector) with the calculated spending delta. The data processing system may then use the labeled feature vector to train a regression set of prediction layers configured to predict spending deltas of accounts.

In another example, the data processing system may analyze the transactions 320 to determine a label for a set of prediction layers configured to generate an account prediction value for a next most frequent spending category. For example, the data processing system may identify the number of transactions the customer corresponding to the account performed when purchasing items in different categories when performing the transactions 320. The data processing system may maintain and increment counters for the categories for each transaction 320 that are associated with or otherwise include an item in the category. The data processing system may identify the category with the highest count and label the concatenated feature vector for the account with an identification of the category. The data processing system may then use the labeled feature vector to train a set of prediction layers (e.g., a classification set of prediction layers) to predict the future most likely spending categories.

In another example, the data processing system may analyze the transactions 320 to determine a label for a set of prediction layers configured to generate an account prediction value for intelligent cash forecasting. For example, the data processing system may collect and identify the data from the transactions 320 to identify the amount of money the customer spent within the time period subsequent to the time period in which the transactions 304 were performed. The data processing system may aggregate the values of the transactions 320 to obtain an aggregated value. The data processing system may label the concatenated feature vector with the aggregated value. The data processing system may then use the labeled feature vector to train a regression set of prediction layers configured to perform intelligent cash forecasting.

In some embodiments, when training the sets of prediction layers of the final layers core 312, the data processing system may train the respective sets of prediction layers with the respectively labeled feature vectors. The data processing system may train the encoders of the pattern recognition core with each of the feature vectors. Accordingly, the data processing system may tune the sets of prediction layers of the final layers core 312 to output different types of account prediction values while training the encoders of the pattern recognition core 310 to output embeddings that enable each of the sets of prediction layers to output accurate account prediction values.

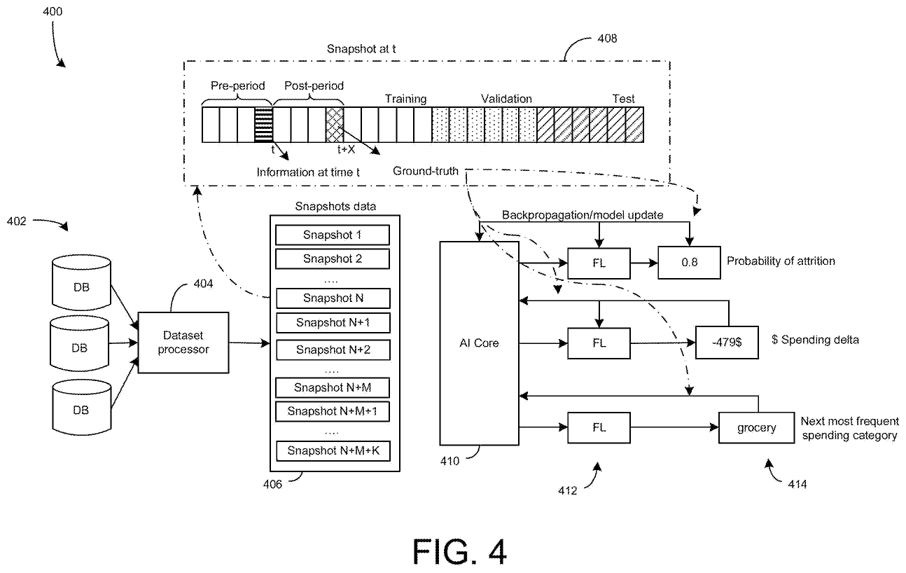

FIG. 4 is an illustration of a sequence 400 for training a model for attrition prediction, in accordance with an implementation. The sequence 400 may include operations that are performed by a data processing system (e.g., the client device 102 or the attrition prediction engine 104, shown and described with reference to FIG. 1, a server system, etc.). The sequence 400 may include more or fewer operations and the operations may be performed in any order.

In the sequence 400, the data processing system may retrieve transaction data, attribute data, and any other data for an account. The data processing system may retrieve such data from data sources 402, which may include, for example, databases in memory of the data processing system and/or databases or memory of remote devices. The data processing system may process the data at 404 to generate snapshots 406 of data for different time periods. The snapshot 408 illustrates an example time period of a snapshot. Each snapshot 406 may include transaction data, account attribute data, etc., for the same account or different accounts for the same or different time periods. Data for the same account may be included in multiple snapshots 406 for different time periods. The data processing system may generate feature vectors (e.g., a feature vector of timeseries transaction data and a feature vector of attribute data) from data of each snapshot 406 and feed the feature vectors into separate encoders of an artificial intelligence core 410. The data processing system may execute the encoders to obtain embeddings from the encoders and concatenate the embeddings together to generate a concatenated embedding. The data processing system may feed the concatenated embedding (or copies of the concatenated embedding) into sets of prediction layers 412 to generate account prediction values 414.

As illustrated in the snapshot 408, the data processing system can divide the data associated with transactions and/or values of attributes associated with the time period of the snapshot 408 into training data, validation data, and testing data. The data processing system may train the artificial intelligence core 410 (including the encoders of the artificial intelligence core 410) and/or the sets of prediction layers 412 using the training data of the snapshot. The data processing system may then validate the training to ensure the accuracy of the artificial intelligence core 410 and/or the sets of prediction layers 412 reaches or exceeds a threshold with data from the snapshot 408. The data processing system may test the artificial intelligence core 410 and/or the sets of prediction layers 412 to make sure the artificial intelligence core 410 and/or the sets of prediction layers 412 are not improperly biased and are accurate enough to be deployed or used to generate account prediction values. In some embodiments, the training data sets are generated from transactions performed earliest in the snapshot 408. The validation data sets may be generated from transactions performed subsequent to the transactions of the training data sets. The testing data sets may be generated from transactions performed subsequent to the transactions of the validation data sets.

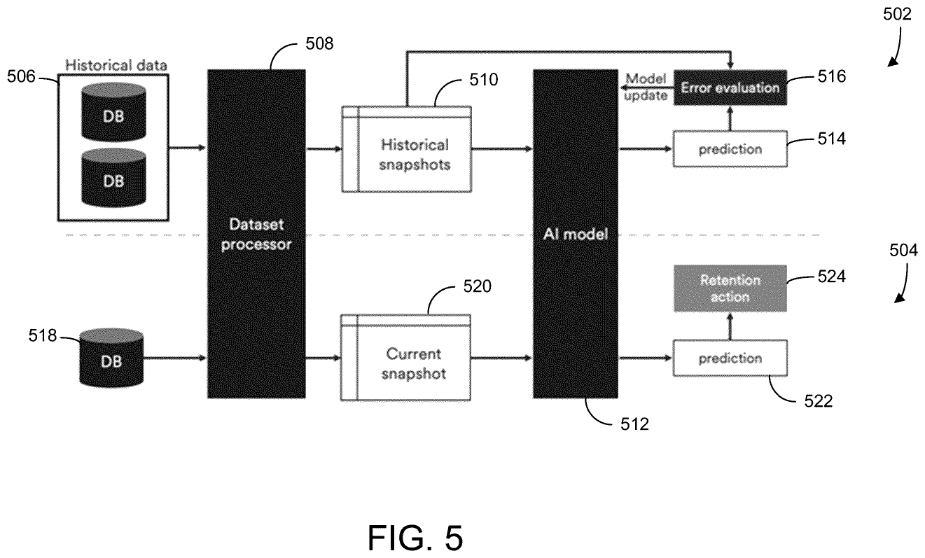

FIG. 5 is an illustration of sequences 502 and 504 for training and executing a model for attrition prediction, in accordance with an implementation. The sequences 502 and 504 may include operations that are performed by a data processing system (e.g., the client device 102 or the attrition prediction engine 104, shown and described with reference to FIG. 1, a server system, etc.). The sequences 502 and/or 504 may include more or fewer operations and the operations may be performed in any order.

In the sequence 502, the data processing system may retrieve historical data 506 from one or more data sources. At 508, the data processing system may generate feature vectors (e.g., historical snapshots 510) from the historical data, such as a feature vector with transaction data in a timeseries based on when the transactions occurred and a feature vector with attribute data as values of attributes in different index values of the feature vector. The data processing system may generate such feature vectors for one or more time periods. The data processing system may input the feature vectors into an artificial intelligence model 512, which may be the same as or similar to the machine learning model 308, shown and described with reference to FIG. 3. The artificial intelligence model 512 may generate a prediction 514 including one or more account prediction values. The data processing system may identify errors 516 in the prediction 514 based on the correct or ground truth values for the one or more account prediction values. The data processing system may then use back-propagation techniques to update the weights and/or parameters of the artificial intelligence model 512. The data processing system may repeatedly insert snapshots of data into the artificial intelligence model 512, testing the accuracy of the model (e.g., the difference between the prediction 514 and the ground truth) until the data processing system determines the artificial intelligence model 512 is accurate to a threshold (e.g., an accuracy threshold).

In the sequence 504, the data processing system may use the artificial intelligence model to generate account prediction values for accounts. In some embodiments, the data processing system performs the sequence 504 for the accounts responsive to determining the artificial intelligence model is accurate to the threshold. The data processing system may retrieve data (e.g., transaction data and attribute data) for an account from a data source 518. The data processing system may generate feature vectors 520 from the retrieved data from the account and input the feature vectors 520 into the artificial intelligence model 512. The data processing system may execute the artificial intelligence model to generate a prediction 522 of one or more account prediction values for the account. The data processing system may apply one or more retention action rules to the one or more account prediction values to select a retention action 524. The data processing system may transmit the retention action to a remote computer in a record with or without the account prediction values of the prediction 522 for further processing or such that an administrator can view the account prediction values and/or the selected retention action 524 to determine whether to implement the retention action 524. In some cases, the data processing system may determine the account prediction values of the prediction 522 do not satisfy any retention action rules. In such cases, the data processing system may transmit the account prediction values and/or a text message to the remote computing device indicating no retention action is required.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices). The operations described in this specification can be implemented as operations performed by a data processing apparatus on data stored on one or more computer-readable storage devices or received from other sources.

The terms “computing device” or “component” encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs (e.g., components of the client device 102 and/or the attrition prediction engine 104) to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks. The processor and the memory can be supplemented by, or incorporated in, special purpose logic circuitry.

While operations are depicted in the drawings in a particular order, such operations are not required to be performed in the particular order shown or in sequential order, and all illustrated operations are not required to be performed. Actions described herein can be performed in a different order. The separation of various system components does not require separation in all implementations, and the described program components can be included in a single hardware or software product.

The phraseology and terminology used herein is for the purpose of description and should not be regarded as limiting. Any references to implementations or elements or acts of the systems and methods herein referred to in the singular may also embrace implementations including a plurality of these elements, and any references in plural to any implementation or element or act herein may also embrace implementations including only a single element. Any implementation disclosed herein may be combined with any other implementation or embodiment.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

The foregoing implementations are illustrative rather than limiting of the described systems and methods. Scope of the systems and methods described herein is thus indicated by the appended claims, rather than the foregoing description, and changes that come within the meaning and range of equivalency of the claims are embraced therein.

What is claimed is:

1. A method, comprising:
generating, by a processor, a first feature vector comprising a plurality of values for a plurality of transactions, each of the plurality of transactions corresponding to an account and performed within a defined time period, and a second feature vector comprising an attribute value of an attribute of the account;
inserting, by the processor, the first feature vector into a first encoder of a machine learning model to generate a transaction embedding and the second feature vector into a second encoder of the machine learning model to generate an attribute embedding;
concatenating, by the processor, the transaction embedding and the attribute embedding to generate a concatenated embedding; and
generating, by the processor, an account prediction value by propagating the concatenated embedding into a set of prediction layers of the machine learning model.

2. The method of claim 1, further comprising:
generating, by the processor, a plurality of account prediction values, including the account prediction value, by propagating the concatenated embedding into each of a plurality of sets of prediction layers, including the set of prediction layers.

3. The method of claim 2, further comprising:
copying, by the processor, the concatenated embedding into a plurality of concatenated embeddings;
labeling, by the processor, each of the plurality of concatenated embeddings with at least one of the plurality of account prediction values generated by the plurality of sets of prediction layers; and
training, by the processor, the plurality of sets of prediction layers with the plurality of labeled concatenated embeddings.

4. The method of claim 3, further comprising training the first encoder and the second encoder with the plurality of labeled concatenated embeddings.

5. The method of claim 2, wherein propagating the concatenated embedding into each of the plurality of sets of prediction layers comprises propagating, by the processor, the concatenated embedding into a regression set of prediction layers and a classification set of prediction layers, the propagating causing the regression set of prediction layers to generate a regression value and the classification set of prediction layers to generate a first classification value and a second classification value.

6. The method of claim 5, further comprising:
applying, by the processor, one or more rules to the regression value and at least one of the first classification value or the second classification value; and
selecting, by the processor, a retention action based on the applying the one or more rules.

7. The method of claim 1, wherein generating the first feature vector comprises labeling, by the processor, the plurality of values for the plurality of transactions with timestamps indicating when the transactions corresponding to the plurality of values were performed.

8. The method of claim 1, further comprising:
generating, by the processor, a third feature vector comprising an identification of an event corresponding to the account and a timestamp for the event; and
inserting, by the processor, the third feature vector into a third encoder of the machine learning model to generate an event embedding,
wherein concatenating the transaction embedding and the attribute embedding to generate a concatenated embedding comprises concatenating transaction embedding, the attribute embedding, and the event embedding to generate the concatenated embedding.

9. The method of claim 8, wherein generating the third feature vector comprising the identification of the event comprises generating the third feature vector comprising an identification of an opening of the account.

10. The method of claim 1, further comprising:
retrieving, by the processor, the plurality of values for the plurality of transactions and the attribute value from a database,
wherein generating the first feature vector and the second feature vector comprises generating, by the processor, the first feature vector and the second feature vector responsive to the plurality of values and the attribute value having a stored association with an identifier of the account in the database.

11. The method of claim 1, wherein generating the second feature vector comprises retrieving, by the processor, a plurality of attribute values for a plurality of account attributes, including the attribute value, for the account attribute, and
inserting, by the processor, the plurality of attribute values into defined index values of the second feature vector.

12. The method of claim 1, wherein inserting the first feature vector into the first encoder comprises inserting, by the processor, the first feature vector into a recurrent neural network, and wherein inserting the second feature vector into the second encoder comprises inserting, by the processor, the second feature vector into a deep neural network.

13. A system, the system comprising:
one or more processors configured by machine-readable instructions to:
generate a first feature vector comprising a plurality of values for a plurality of transactions, each of the plurality of transactions corresponding to an account and performed within a defined time period, and a second feature vector comprising an attribute value of an attribute of the account;
insert the first feature vector into a first encoder of a machine learning model to generate a transaction embedding and the second feature vector into a second encoder of the machine learning model to generate an attribute embedding;
concatenate the transaction embedding and the attribute embedding to generate a concatenated embedding; and
generate an account prediction value by propagating the concatenated embedding into a set of prediction layers of the machine learning model.

14. The system of claim 13, wherein the one or more processors are further configured to:
generate a plurality of account prediction values, including the account prediction value, by propagating the concatenated embedding into each of a plurality of sets of prediction layers, including the set of prediction layers.

15. The system of claim 14, wherein the one or more processors are further configured to:
copy the concatenated embedding into a plurality of concatenated embeddings;
label each of the plurality of concatenated embeddings with at least one of the plurality of account prediction values generated by the plurality of sets of prediction layers; and
train the plurality of sets of prediction layers with the plurality of labeled concatenated embeddings.

16. The system of claim 15, wherein the one or more processors are further configured to train the first encoder and the second encoder with the plurality of labeled concatenated embeddings.

17. A non-transitory computer-readable storage medium having instructions embodied thereon, the instructions being executable by one or more processors to perform a method, the method comprising:
generating first feature vector comprising a plurality of values for a plurality of transactions, each of the plurality of transactions corresponding to an account and performed within a defined time period, and a second feature vector comprising an attribute value of an attribute of the account;
inserting the first feature vector into a first encoder of a machine learning model to generate a transaction embedding and the second feature vector into a second encoder of the machine learning model to generate an attribute embedding;
concatenating the transaction embedding and the attribute embedding to generate a concatenated embedding; and
generating an account prediction value by propagating the concatenated embedding into a set of prediction layers of the machine learning model.

18. The non-transitory computer-readable storage medium of claim 17, the method further comprising:
generating a plurality of account prediction values, including the account prediction value, by propagating the concatenated embedding into each of a plurality of sets of prediction layers, including the set of prediction layers.

19. The non-transitory computer-readable storage medium of claim 18, the method further comprising:
copying the concatenated embedding into a plurality of concatenated embeddings;
labeling each of the plurality of concatenated embeddings with at least one of the plurality of account prediction values generated by the plurality of sets of prediction layers; and
training the plurality of sets of prediction layers with the plurality of labeled concatenated embeddings.

20. The non-transitory computer-readable storage medium of claim 19, the method further comprising training the first encoder and the second encoder with the plurality of labeled concatenated embeddings.
